(19) United States
(12) Patent Application Publication
(10) Pub. No.: US 2010/0088025 A1
(43) Pub. Date: Apr. 8, 2010

(54) Route mapping system and method

(75) Inventors: Dinesh Kumar Garg, Roorkee (IN); Manish Poddar, Burhanpur (IN)

Correspondence Address: QUALCOMM INCORPORATED, 5775 MOREHOUSE DR., SAN DIEGO, CA, 92121, US

(73) Assignee: ATI Technologies ULC, Markham (CA)

(21) Appl. No.: 12/268,652

(22) Filed: Nov. 11, 2008

(30) Foreign Application Priority Data
Oct. 7, 2008 (IN) 2463/CHE/2008

(51) Int. Cl. G01C 21/34

(52) U.S. Cl. 701/209; 701/211

(57) ABSTRACT

A route mapping system includes a route module, a wireless coverage module, and a wireless coverage route module. The route module provides a plurality of routes in response to origination and destination information. The wireless coverage module provides wireless coverage information for a plurality of wireless service providers in response to the plurality of routes. The wireless coverage route module provides a plurality of wireless coverage routes in response to the plurality of routes and the wireless coverage information.

### CROSS-REFERENCE TO RELATED APPLICATION

The present patent application claims priority from and the benefit of Indian Patent Application No. 2403/CHE/2008, filed Oct. 7, 2008, and entitled Route Mapping System and Method, which prior application is hereby incorporated herein by reference.

### FIELD

The present disclosure generally relates to geographic mapping information, and more particularly, to providing route maps based on geographic mapping information.

### BACKGROUND

Route mapping methods are generally used to identify one or more routes between an origination location and a destination location. The routes are typically determined based on certain user identified criteria, such as shortest travel distance, shortest travel time, and other suitable criteria.

In some circumstances, it may be desirable to provide a route map so that the user can use a wireless device during the route. In one method, a route map is provided based on a particular service provider's wireless coverage for a wireless device. However, in some geographic areas, that particular service provider may not provide wireless coverage and therefore the route would not have complete wireless coverage or, alternatively, the desired route may have wireless coverage but using a separate (and perhaps more expensive) “roaming” carrier. Therefore, it is desirable, among other things, to provide a system and method that is capable of providing one or more route maps without the aforementioned shortcoming.

### BRIEF DESCRIPTION OF THE DRAWINGS

The disclosure will be more readily understood in view of the following description when accompanied by the below figures, wherein like reference numerals represent like elements:

FIG. 1 is an exemplary functional block diagram depicting a route mapping system;

FIG. 2 is a flowchart depicting exemplary operations of the route mapping system;

FIG. 3 is an exemplary diagram of a user interface of the route mapping system;

FIG. 5 is an exemplary diagram of a graphical route provided by the route mapping system; and

FIG. 6 is an exemplary diagram of a textual route provided by the route mapping system.

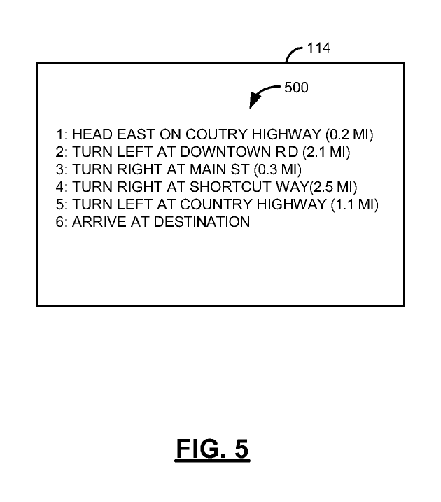

### DETAILED DESCRIPTION

In one example, a route mapping system includes a route module, a wireless coverage module, and a wireless coverage route module. The route module provides a plurality of routes in response to origination and destination information. The wireless coverage module provides wireless coverage information for a plurality of wireless service providers in response to the plurality of routes. The wireless coverage route module provides a plurality of wireless coverage routes in response to the plurality of routes and the wireless coverage information. A related method is also disclosed.

Among other advantages, the system and method provides multiple wireless coverage routes between an origination and destination for a wireless device. The multiple wireless coverage routes are provided by multiple service providers. As such, a user can determine which wireless service provider to subscribe to based on commonly traveled routes or other suitable information. In addition, a user can determine which route to take based on other considerations such as whether the wireless device will roam between service providers (and, thus, likely increase cost), a shortest distance traveled, a shortest time duration, a non-toll road route, and/or other suitable considerations. Other advantages will be recognized by those of ordinary skill in the art.

In one example, the route mapping system includes a route database module that stores the plurality of routes. The route module retrieves the plurality of routes from the route database module in response to the origination and destination information. In one example, the route mapping system includes a wireless coverage database module that stores the wireless coverage information. The wireless coverage route module retrieves the wireless coverage information from the wireless coverage database module in response to the origination and destination information.

In one example, the route mapping system includes a user interface module that communicates the origination and destination information to the wireless coverage route module. In one example, the route mapping system includes a display that displays a graphical route and/or a textual route based on the plurality of wireless coverage routes. In one example, the route mapping system includes a speaker that provides an audible representation of at least one of the plurality of wireless coverage routes.

In one example, the plurality of wireless service providers provide at least voice calling capability. In one example, the plurality of wireless coverage routes are based on distance information, travel time information, road toll information, and/or wireless service type information.

In one example, a computer readable medium includes information that when executed by at least one processor causes the at least one processor to operate, design, and/or organize a circuit that includes at least the route module, the wireless coverage module, and the wireless coverage route module. In one example, the information includes hardware description language.

As used herein, the term “circuit” and/or “module” can include an electronic circuit, one or more processors (e.g., shared, dedicated, or group of processors such as but not limited to microprocessors, DSPs, or central processing units) and memory, that execute one or more software or firmware programs, combinational logic circuits, an ASIC, and/or other suitable components that provide the described functionality. As will be appreciated by those of ordinary skill in the art, the operation, design, and organization, of a “circuit” or “module” can be described in a hardware description language such as Verilog™, VHDL, or other suitable hardware description languages.

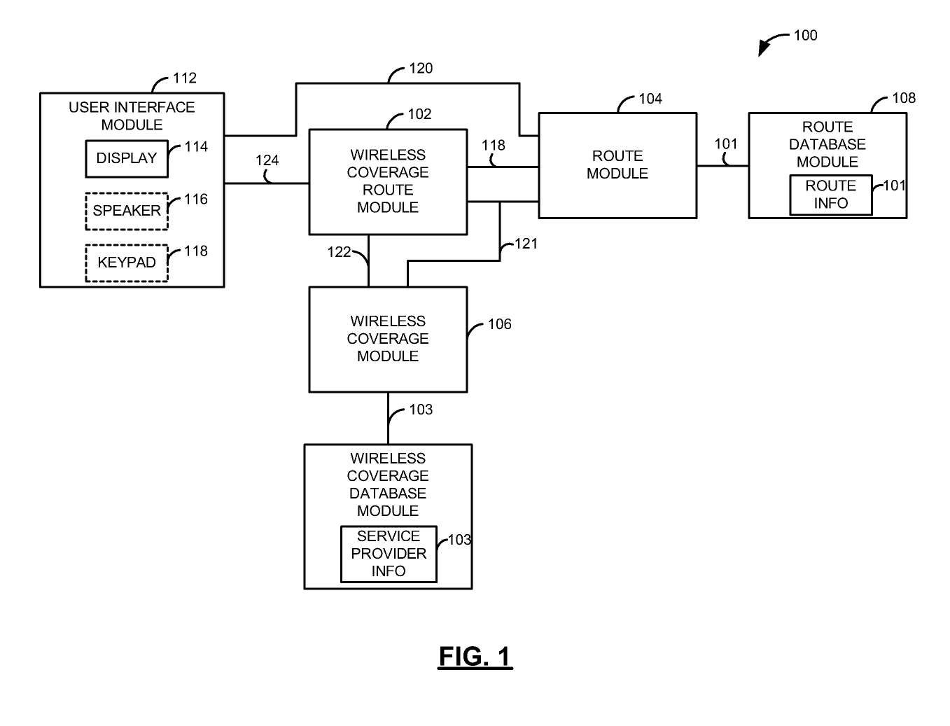

Referring now to FIG. 1, an exemplary functional block diagram of a route mapping system 100 is depicted. The route mapping system 100 includes a wireless coverage route module 102, a route module 104, and a wireless coverage module 106. The route module 104 provides a plurality of routes 118 in response to origination and destination information 120. The wireless coverage module 106 provides wireless coverage information 122 for a plurality of wireless service providers in response to the plurality of routes 121. The wireless service providers can provide any suitable wireless service such as voice calling service, data service, streaming media service, and/or other suitable services. In some embodiments, it may be desirable for a wireless device to be capable of making and/or receiving telephone calls while traversing one of the plurality of routes 118. As such, in these embodiments, the wireless service providers should provide at least voice calling capability.

The wireless coverage route module 102 provides a plurality of wireless coverage routes 124 in response to the plurality of routes 121 and the wireless coverage information 122. The plurality of wireless coverage routes 124 include routes that have wireless coverage for the plurality of wireless service providers. Accordingly, a user of the route mapping system 100 can choose to traverse one or more of the plurality of routes 121 to ensure that wireless coverage is available for a wireless device. In addition, the user can also use the route mapping system 100 to aid in determining which wireless service provider to subscribe to based on routes that they commonly travel.

The route mapping system 100 can also include a route database module 108 and a wireless coverage database module 110. The route module 104 communicates with the route database module 108 and the wireless coverage module 106 communicates with the wireless coverage database module 110. In some embodiments, the route module 104 and the wireless coverage module 106 are operatively coupled to the route database module 108 and the wireless coverage database module 110, respectively. In other embodiments, the route module 104 and the wireless coverage module 106 communicate with the route database module 108 and the wireless coverage database module 110, respectively, via any suitable wired or wireless communication network.

The route database module 108 stores route information 101 and the wireless coverage database module 110 stores service provider information 103. The route information 101 includes information such as road information, highway information, speed limit information, toll road information, and/or other suitable route information. The service provider information 103 includes wireless coverage location information for multiple wireless services providers. The wireless coverage information can include, among other things, cell site locations, wireless propagation information, and/or wireless interference information. The route module 104 retrieves the route information 101 from the route database module 108 and provides the plurality of routes 118 based thereon. The wireless coverage module 106 retrieves the service provider information 103 and provides the wireless coverage information 122 based thereon.

The route mapping system 100 can also include a user interface module 112. The user interface module 112 provides the origination and destination information 120 to the route module 104 and receives the wireless coverage routes 124 from the wireless coverage module 102. The user interface module 112 can include a display 114 and in some embodiments a speaker 116. The display 114 can provide a graphical and/or textual representation of the wireless coverage routes 124 and the speaker 116 can provide an audible representation of the wireless coverage routes 124. The display 114 can be any suitable display such as an LCD display, a plasma display, an LED display, or other suitable display. In some embodiments, the display 114 can provide a graphical user interface so that the user can interact with the user interface module 112. In some embodiments, the user interface module 112 can include a keypad 118 or other suitable input mechanism so that the user can interact with the user interface module 112.

In one embodiment, the wireless coverage route module 102, the route module 104, wireless coverage module 106, and the user interface module 112 can be included in a wireless handheld device such as a cellular phone, personal digital assistant, or other suitable wireless device. As such, the route module 104 and the wireless coverage module 106 communicate wirelessly with the route database module 108 and the wireless coverage database module 110, respectively. In another embodiment, the user interface module 112 can be included in the wireless handheld device and can communicate wirelessly with the wireless coverage route module 102 and the route module 104. In yet another embodiment, the wireless coverage route module 102, the route module 104, wireless coverage module 106, the route database module 108 the wireless coverage database module 110, and the user interface module 112 can be included in a suitable device such as a wireless handheld device, a stationary or laptop computer, or other suitable device.

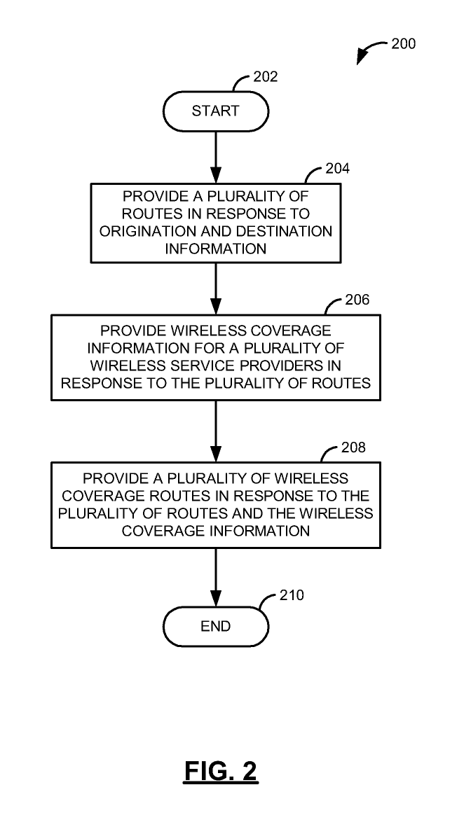

Referring now to FIG. 2, exemplary operations of the route mapping system 100 are generally identified at 200. The process starts at 202 when a user provides the origination and destination information 120. At 204, the route module 104 provides the plurality of routes 118 in response to the origination and destination information 120. At 206, the wireless coverage module 106 provides the wireless coverage information 122 in response to the plurality of routes 118. At 208, the wireless coverage route module 102 provides the plurality of wireless coverage routes 124 in response to the plurality of routes 118 and the origination and destination information 120. The process ends at 210.

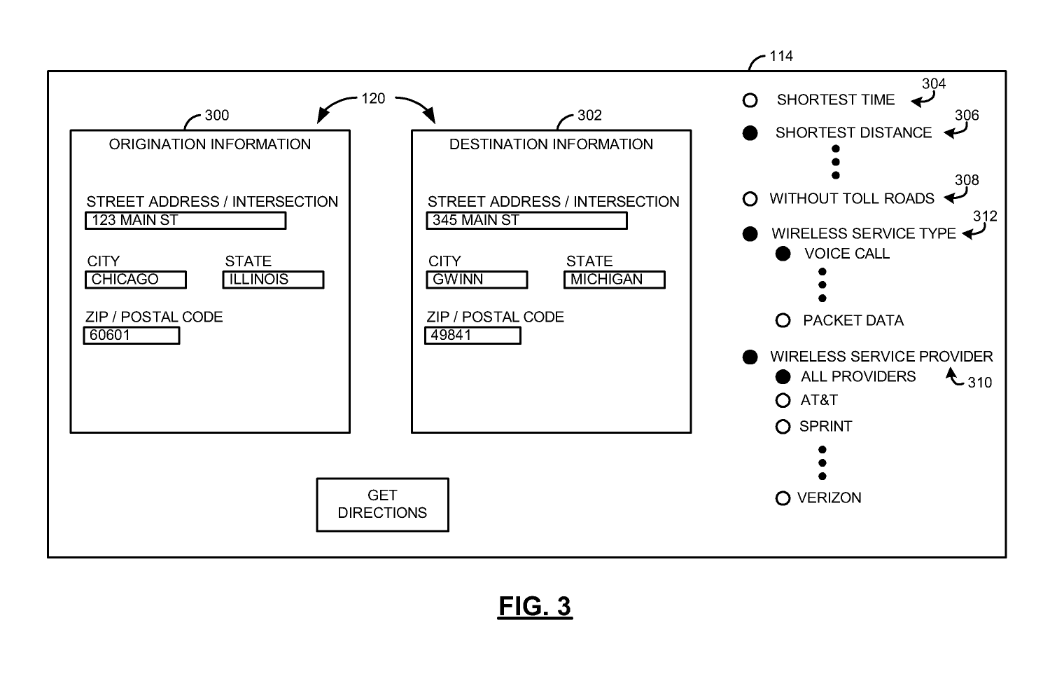

Referring now to FIG. 3, an exemplary depiction of the display 114 is shown. In this example, the display 114 provides a graphical user interface. A user can input the origination and destination information 120. More specifically, a user can input origination information 300 and destination information 302 as shown. In addition, the user can select how one or more routes are to be determined by the route mapping system 100. For example, the user can request one or more routes having a shortest time 304, a shortest distance 306, a non-toll road route 308. In addition, the user can request one or more routes based on wireless coverage of one or more wireless service providers 310. Furthermore, the user can request one or more routes based on types of wireless services 312 that are available to the user while traversing the route. Those of ordinary skill in the art will appreciate that routes can be determined based on other suitable user specified characteristics. Such wireless coverage, type of wireless services available in a particular coverage and costs (e.g., standard and/or roaming associated costs) are examples of wireless coverage metrics or measurements. Optimizing such wireless coverage metric may include, for example, maximizing a base level of functionality (e.g., voice capability) over selected route between an origin and a destination, maximizing a particular service (e.g., wireless e-mail) over a selected route, minimizing cost associated with operating a mobile device over a particular route (e g , minimizing roaming charges or maximizing the bandwidth availability) or the like.

Referring now to FIG. 4, an exemplary depiction of a graphical representation of the plurality of routes 124 is shown. In this example, there are three wireless services providers, namely, Provider A 400, Provider B 402, and Provider C 404. As shown, Provider A 400 provides wireless service at locations 406 and 408; Provider B 402 provides wireless service at location 410; and Provider C 404 provides wireless service at locations 412, 414, 416, and 418. In addition, as shown, all of the wireless service providers 400, 402, 404 provide wireless service at locations 420 and 422. As shown, only Provider C 404 provides a complete route from the origination to the destination. As such, a user that commonly travels between the origination and destination can use the plurality of routes 124 to choose Provider C 404 as their wireless service provider if desired. In addition, a user who is more concerned about travel time than wireless roaming fees (costs) may choose a shorter path based on the plurality of routes 124.

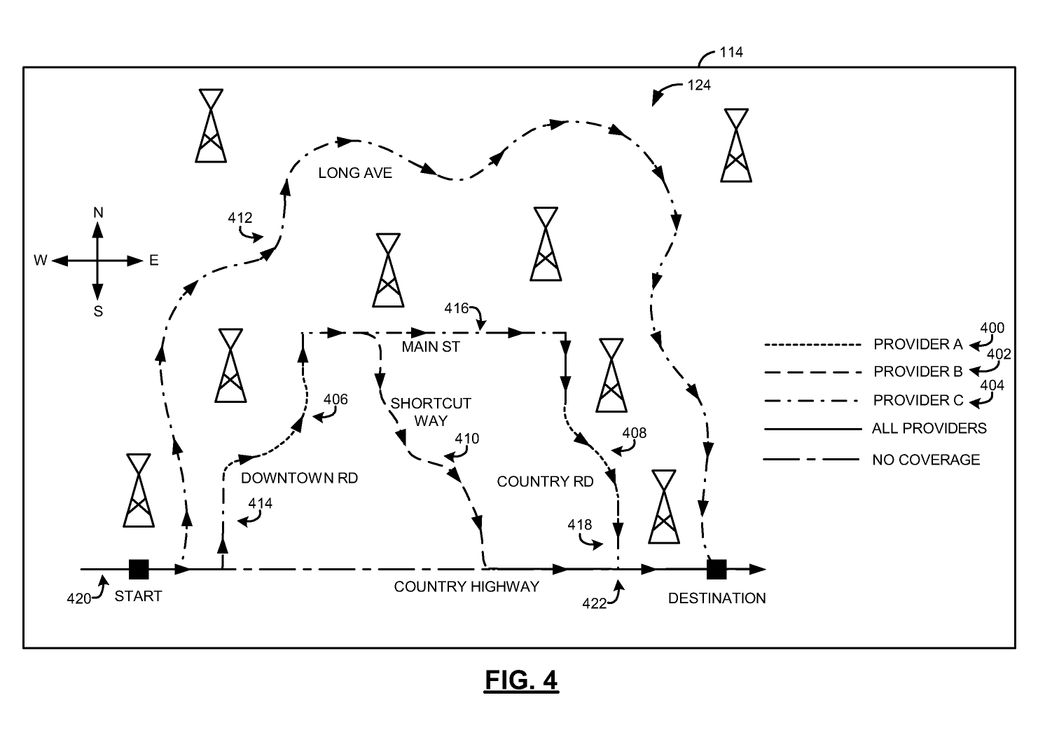

Referring now to FIG. 5, an exemplary depiction of a textual representation 500 of the plurality of routes 124 is shown. In this example, a shortest travel distance (or time) has been selected without regard to a particular service provider so that a wireless device can roam between providers. As such, the textual representation 500 in this example provides turn by turn directions from the origination to the destination having the shortest distance (or time) having wireless coverage provided by any carrier. In some embodiments, the user interface module 112 can include a text to speech (T2S) module (not shown) that translates the textual representation 500 into an audible representation of the textual representation 500. The T2S module can be any known module capable of translating text to speech. The speaker 116 can use the audible representation to communicate the textual representation 500 audibly to the user.

As noted above, among other advantages, the system and method provides multiple wireless coverage routes between an origination and destination for a wireless device. The multiple wireless coverage routes are provided by multiple service providers. As such, a user can determine which wireless service provider to subscribe to based on commonly traveled routes or other suitable information. In addition, a user can determine which route to take based on other considerations such as whether the wireless device will roam between service providers, a shortest distance traveled, a shortest time duration, a non-toll road route, and/or other suitable considerations. Other advantages will be recognized by those of ordinary skill in the art.

Also, integrated circuit design systems (e.g., work stations) are known that create integrated circuits based on executable information stored on a computer readable memory such as but not limited to CDROM, RAM, other forms of ROM, hard drives, distributed memory etc. The information may include data representing (e.g., compiled or otherwise represented) any suitable language such as, but not limited to, hardware descriptor language or other suitable language. As such, the circuits and/or modules described herein can also be produced as integrated circuits by such systems. For example, an integrated circuit can be created for use in a display using information stored on a computer readable medium that when executed cause the integrated circuit design system to create an integrated circuit includes a route module, a wireless coverage module, and a wireless coverage route module. The route module provides a plurality of routes in response to origination and destination information. The wireless coverage module provides wireless coverage information for a plurality of wireless service providers in response to the plurality of routes. The wireless coverage route module provides a plurality of wireless coverage routes in response to the plurality of routes and the wireless coverage information. Integrated circuits having a circuit and/or module that performs other operations described herein may also be suitable produced.

While this disclosure includes particular examples, it is to be understood that the disclosure is not so limited. Numerous modifications, changes, variations, substitutions, and equivalents will occur to those skilled in the art without departing from the spirit and scope of the present disclosure upon a study of the drawings, the specification, and the following claims.

What is claimed is:

1. A route mapping system, comprising:
a route module that is operative to provide a plurality of routes in response to origination and destination information;
a wireless coverage module that is operative to provide wireless coverage information for at least one service provider in response to the plurality of routes; and
a wireless coverage route module that is operative to provide a plurality of wireless coverage routes in response to the plurality of routes and the wireless coverage information.

2. The route mapping system of claim 1 further comprising a route database module that is operative to store route information, wherein the route module provides the plurality of routes based on the route information.

3. The route mapping system of claim 1 further comprising a wireless coverage database module that is operative to store wireless service provider information, wherein the wireless coverage route module provides the wireless coverage information based on the wireless service provider information.

4. The route mapping system of claim 1 further comprising a user interface module that is operative to communicate the origination and destination information to the wireless coverage route module.

5. The route mapping system of claim 1 further comprising a display that is operative to display at least one of a graphical route and a textual route based on the plurality of wireless coverage routes.

6. The route mapping system of claim 1 wherein the plurality of wireless coverage routes are based on at least one of a distance information, a travel time information, road toll information, and wireless service type information.

7. The route mapping system of claim 1 further comprising a speaker that is operative to provide an audible representation of at least one of the plurality of wireless coverage routes.

8. A method of providing a route map, comprising:
providing a plurality of routes in response to origination and destination information;
providing wireless coverage information for a plurality of wireless service providers in response to the plurality of routes; and
providing a plurality of wireless coverage routes in response to the plurality of routes and the wireless coverage information.

9. The method of claim 8 further comprising providing the wireless coverage information based on wireless service provider information.

10. The method of claim 8 further comprising displaying at least one of a graphical route and a textual route based on the plurality of wireless coverage routes.

11. A method of providing a providing a route map, comprising:
responsive to origination and destination information and wireless coverage information for at least one wireless service provider, providing a wireless coverage route that optimizes at least one wireless coverage metrics over route between said origination and destination.

12. The method of claim 11 wherein said at least one wireless coverage metric comprises one or more of: wireless coverage, wireless services available in said wireless coverage, and costs.

13. The method of claim 12 further comprising: providing a plurality of routes responsive to origination and destination information and wireless coverage information for said at least one service provider.

14. The method of claim 13 further comprising:
providing wireless coverage information for said at least one wireless service provider.

15. A computer readable medium comprising executable instructions that when executed by at least one processor causes the at least one processor to:
provide a plurality of routes in response to origination and destination information;
provide wireless coverage information for a plurality of wireless service providers in response to the plurality of routes; and
provide a plurality of wireless coverage routes in response to the plurality of routes and the wireless coverage information.

16. The computer readable medium of claim 15 wherein the plurality of wireless service providers provide at least voice calling capability.

17. The computer readable medium of claim 15 further comprising providing the plurality of routes based on route information and providing the wireless coverage information based on wireless service provider information

18. The computer readable medium of claim 15 further comprising displaying at least one of a graphical route and a textual route based on the plurality of wireless coverage routes.

19. The computer readable medium of claim 15 wherein the plurality of wireless coverage routes are based on at least one of a distance information, a travel time information, road toll information, and wireless service type information.
